(19) United States
(12) Patent Application Publication
(10) Pub. No.: US 2022/0287916 A1
(43) Pub. Date: Sep. 15, 2022

(54) A Teat

(71) Applicant: TARSIA, Antonio, London (GB)

(72) Inventor: Antonio Tarsia, London (GB)

(21) Appl. No.: 17/639,438

(22) PCT Filed: Sep. 4, 2020
(86) PCT No.: PCT/EP2020/074782

§ 371 Date: Mar. 1, 2022

(30) Foreign Application Priority Data
Sep. 4, 2019 (GB) 1912695.2
Aug. 18, 2020 (GB) 2012894.8

(51) Int. Cl. A61J 11/00; A61J 9/04; A61J 11/04

(52) U.S. Cl. CPC A61J 11/007; A61J 11/005; A61J 11/004; A61J 9/04; A61J 11/04

(57) ABSTRACT

A teat for a milk bottle is provided. The teat comprises an attachment portion for attaching the teat to a milk bottle. A breast portion of the teat extends from the attachment portion, the breast portion including a compressible material. A nipple portion of the teat extends from the breast portion. The nipple portion is narrower than the breast portion and includes an outlet. A milk-flow pathway extends through the breast portion, the compressible material and the nipple portion for the passage of milk from a milk bottle attached to the attachment portion to the outlet. The breast portion includes a flexible skin fully enclosing the compressible material, the flexible skin separating the compressible material from the milk-flow pathway.

### BACKGROUND

It is well known to use bottle feeding as a supplement or alternative to breast feeding of infants and young children. This may be due to medical or logistical reasons or for personal choice. Given the concern for children's long term health and development, there is much debate in the field as to the relative merits of breastfeeding and bottle feeding and the implications thereof.

Two areas where bottle feeding may cause issues lie in what is known as “nipple confusion” and the initiation of malocclusion. Nipple confusion is a common problem among young infants which are fed via a mix of breast feeding and bottle feeding. The World Health Organisation recommends at least 6 months of exclusive breast feeding followed by a continuation as long as the mother and infant are happy to do so.

However, this is not always possible for various reasons such as work commitments, lack of milk, or health issues relating to breast feeding. It is therefore very common that parents provide a mixture of breast feeding and bottle feeding. However, this mixed feeding regime may cause issues for the infant. In particular, they may not accept the mixed feeding regime and reject one of the breast or the bottle, or they may encounter adaptation problems caused by the difference between the two. This is known as nipple confusion and can manifest in the infant having difficulties in latching and suckling from the breast if they are frequently exposed to the bottle while they are still learning. Once the feeding behaviour has been established the infant may refuse either of the bottle or the breast. This can therefore cause problems as the infant may be unable to drink from one of the bottle or breast and hence any possible flexibility is removed.

Malocclusion is the misalignment or incorrect relation between the teeth of the two dental arches when they approach each other as the jaws close. It is well established in the scientific community that breastfeeding encourages a proper development of the infant's mouth and reduces the development of malocclusion. This is set out, for example, in the article Breastfeeding, Bottle Feeding Practices and Malocclusion in the Primary Dentition; a Systematic Review of Cohort Studies of Hermont et al., the entire contents of which are hereby incorporated by reference, which presents a meta-analysis of the field. This malocclusion results in poor alignment of the teeth and a distorted architecture of the facial bones. This is caused by an improper development of the infant's skull. Environmental factors such as breastfeeding, feeding behaviours in general and breathing habits can have a large impact on the development of the bones in the face and mouth of the infant and as such, any change to these can result in improper or insufficient stimulation which may initiate or encourage malocclusion.

Both of the above issues arise due to the fundamental differences between teats for infant milk bottles which are presently on the market and the human breast. These teats are typically formed of a hollow teat component made of silicon. The consistency and overall mechanical properties and response of these teats is completely different to the properties and response of a breast. As a result, the method in which the infant activates their muscles to obtain milk from the bottle is completely different to the method in which they activate their muscles to extract milk from the breast. A seminal study of this is set out in Reduction of Masseter Muscle Activity in Bottle-Fed Babies of Inoue et al., the entire contents of which is herein incorporated by reference. In this study, it was shown that the activation of the muscles of the mouth is different between bottle and breastfeeding in a quantitative and qualitative way.

In particular, during breastfeeding there is a major activation of the masseter muscle. The masseter muscle connects the mandible (lower jaw bone) and the cheek bone and plays a major role in the chewing of solid foods. As such, this is one of the main mastication muscles and one of the strongest in the infant's body. This muscle provides the infant the strength to suck the milk from the breast.

During bottle feeding the masseter muscle does not play a significant role and instead other muscles are engaged for this task. For example, the buccinators muscle plays a major part. The buccinators muscle acts to compress the cheeks and is a relatively small muscle. The tip of the infant's tongue behaves as a rigid body under the nipple during suckling. This different activation of muscles is the underlying cause for the issues described above.

Fundamentally, nipple confusion arises as the infant is required to perform a completely different muscle performance when feeding from the bottle compared to breastfeeding. While adult human beings can cope with such changes in behaviour across different situations, infants have a limited capacity of adaption and may struggle to understand the difference between the two.

In some baby bottles, the teat must be compressed in order to allow milk flow in the absence of suction. That is, the teat may include an integral valve which is opened and closed by apply compression on the teat. The valve may be provided, for example, in a nipple portion of the teat. This is a completely different mechanism to that which takes place during breastfeeding. Additionally, when the teat is compressed there is a risk of the milk flow pathway collapsing, thereby preventing further milk flow. The infant cannot understand why this has happened and it may present further issues

As a result of this fundamentally different operation method, conventional teats are very different from human breasts, resulting in the issues discussed above and below. For example, during breastfeeding the nipple of the lactating breast has a much harder consistency than the surrounding areola and breast tissue. In order to facilitate the method of drinking above the nipple of conventional teats is typically equally or similarly flexible as the rest of the teat.

The link to malocclusion lies in how the development of the mouth, face and muscles is reliant at least partly upon the environment. Breastfeeding reduces the development of dental issues as it encourages muscular function which is similar to a tougher natural diet. Historically, infants were breast-fed for a long period of time and this may have generated an evolutionary link to proper development of the facial muscles.

There is therefore a need for an improved teat for a milk bottle which address these issues.

Similar malocclusion issues may arise from the use of a pacifier (also known as a dummy, soother or teether) by the infant as summarised, for example, in The effect of pacifier sucking on orofacial structures: a systematic literature review of Schmid et al., the entire contents of which is hereby incorporated by reference. The teat portions on pacifiers are also very similar to traditional teats for bottles. Thus, the same issues regarding nipple confusion arise with the use of pacifiers.

JP S63 24948 A discloses a nipple for infant feeding. Generally the entire nipple portion is filled with a material, with a reservoir formed in a flow pathway. To actuate the flow of milk from the teat, it must be compressed to thereby force the milk from the reservoir. This mechanism is again very different to a normal breastfeeding mechanism.

WO 2010/046812 A1 discloses a teat comprising a body defined by a flexible wall. The nipple portion of this teat is generally flexible as it is not formed as a solid component, but instead an outer skin around a void. This flexible nipple portion is necessary as the operation of the teat relies upon an infant performing a peristaltic stripping movement with its tongue. In order to achieve this, the shape of the teat must necessarily deviate from an anatomical shape and structure corresponding to a breast.

The disclosure of each of JP S63 24948 A and WO 2010/046812 A1 appears to have been motivated by early theories regarding the mechanism of breastfeeding. These theories are the chewing mechanism and tongue-stripping principle respectively, which have since been rejected.

The early theory used in JP S63 24948 A supposed that infants should apply a sort of “chewing” action on the teat. Such chewing does activate the masseter muscle. However, it is now clear that the extraction of milk is not caused by compression of the breast or the nipple. On the contrary, the extraction of the milk happens when the pressure on the nipple decrease and the infant increases the volume of the oral cavity. To require this chewing action, the teat may include a valve which is opened and closed by the mechanism of the infant chewing on the teat. In operation the valve would comprise of an aperture that would open and close by the mechanism of the infant chewing on the teat providing a milk flow pathway. This is a completely different mechanism to that which takes place during breastfeeding. Additionally, when the teat is chewed there is a risk of the milk flow pathway collapsing, thereby preventing further milk flow.

U.S. Pat. No. 1,048,459 A discloses a cheap throw-away feeding nipple for babies. This nipple includes a plug of sponge retained within a nipple portion. The purpose of this disclosure is for milk to flow through the sponge. In preferred embodiments the sponge is an open-celled sponge to avoid clogging (as the milk can flow multiple ways through the sponge, it does not matter if any get clogged). In a less-preferred embodiment a closed-celled sponge is provided with an open channel extending therethrough. Again, the milk directly contacts the sponge. Similar designs are provided in GB 2 285 621 A and CN 2158270 Y.

US 2009/0139950 A1 discloses a teat for feeding bottles with a suction body formed as an integral moulded component, i.e. it is not hollow. A rigid head made of a hard plastic is provided as an attachment mechanism for the suction body. As such the portion of the suction body around the rigid head will be less compressible than the nipple portion.

A further issue with existing milk bottles is the potential for causing colic.

Colic is a common occurrence for babies and infants, and it is defined as severe pain in the abdomen. The main manifestation of colic is crying which can last for several hours and be repeated over several days and weeks. Colic events usually happen during the late afternoon or during the evening and even though it does not cause long term effects, it is a painful and stressful experience for both the baby and the parents. In extreme cases, this can lead and/or contribute to postnatal depression, increased visit to the doctor and even child abuse. Colic typically affects between 10% to 40% of babies and it is common in the first six weeks of the baby's life, before typically disappearing as the baby reaches 3 months to 6 months of age.

The causes of colic are still debated, and the colic is normally diagnosed if the continuous and frequent crying episodes are not caused by any other problem. A possible cause of pain for the baby is theorised to be accumulation of air into the gastrointestinal system. The air can cause obstructions and hence pain. Air can be ingested while crying, sucking on a pacifier or while eating from the breast or baby bottles. The ingestion of air during feeding normally happens during interruption of sucking. When the feeding is interrupted, the baby might undo the latch and open their mouth to atmospheric air. Because babies have poor control of their movements, they might swallow the air if it enters their oral cavity during feeding.

While colic can affect breastfed babies as well, colic is often associated with the use of baby bottles. Babies will invariably need to undo the latch on the bottle because a pressure differential inside the bottle is created by the sucking motion. During breastfeeding, the contraction of the lactiferous duct system causes a decrease of the volume of the cavity containing milk which offsets the extraction of milk; this avoids the building of a differential pressure between the ductal system of the breast and the atmospheric pressure. The milk can flow out of the breast as long as the let-down reflex causes the contraction of the ductal system.

This continuous flow milk also means uninterrupted feeding for the baby. Typically, baby bottles have a rigid walled container. As the container does not vary in size, the extraction of milk will cause a pressure differential to build between the bottle and the atmospheric air. The pressure differential will make the extraction of milk more difficult and the baby will need to spend more effort in order to feed. When the pressure differential exceeds a certain limit, the baby will not be able to feed any more because the effort required to extract the milk is beyond the baby's capability and/or because the nipple of the bottle may collapse under atmospheric pressure.

This means that the baby will need to interrupt their feeding, undo the latch and open their mouth. While doing this, the outlet hole on the nipple of the bottle will allow air to enter in the bottle and equilibrate the pressure differential. When the pressure differential is equalised, the baby can latch and start feeding again. This series of events will repeat cyclically during feeding and every time the baby undoes the latch and opens their mouth to the atmospheric air there is the possibility of them ingesting air. The ingested air can then cause a colic event.

In order to avoid the building of a pressure differential inside the baby bottle, it is useful to have an air venting system that will allow the selective ingress of air in the bottle during feeding. The air venting system allows the selective ingress of air during feeding. The ingress of air in the bottle will avoid the creation of a differential pressure and hence interruption of feeding. If the feeding is not interrupted, the baby will not need to undo the latch and open their mouth hence making the ingestion of air less probable. Because air ingestion is thought to be cause of colic, air-venting systems for baby bottles are commonly called anti-colic systems.

Several anti-colic systems are available on the market and the two common problems affecting them are leaking of fluids and inefficiency. The leakage happens when the anti-colic valve does not always manage to prevent spillage of fluids; this should not happen because the valve should allow selective ingress of air only. Other anti-colic systems are built with deformable parts (like rubber or similar) which are opened by the differential pressure. These anti-colic systems can be rather inefficient because the differential pressure needed to open the valve might be so high as to exceed the baby's capability to pump out milk. Alternatively, if the pressure differential needed to open the valve is too low the valve will open too often and cause leaking.

There is therefore the need for an improved air valve for a milk bottle.

U.S. Pat. No. 3,797,521 A discloses a dispensing closure for parenteral fluid containers. This includes a flexible disc 52 which is forced by a ball 54 to seal with a valve seat 62. This arrangement is required as air pressure is required to force the flexible disc 52 from the valve seat 62. The closure is not tilted or the like during use, but instead maintains a 30° angle towards the floor. Any introduction of secondary valve seats would prevent this air-pressure triggering and thereby prevent the closure from operating as required.

GB 1553939 A discloses a non-return valve for vacuum-operated apparatus of motor vehicles. A diaphragm 10 with a central opening 15 is forced towards a valve seat by a spring 4. A vacuum is applied to lift the diaphragm 10 from its seat to allow air-flow therethrough. Again, the non-return valve is not tilted or the like so as to act under gravity. Further, any introduction of secondary valve system would prevent this vacuum-operated actuation.

WO 2014/105452 A discloses a valve assembly for a tank of a vehicle. In certain shown examples, a blocking element 92 is provided to allow for gas venting. During vacuum actuation, this blocking element 92 is not displaced from its seat. The valve seat 88 must be a rigid non-deformable element in order for this valve assembly to operate.

### SUMMARY

The present invention provides a teat for a milk bottle according to claim 1. This teat for a milk bottle more accurately simulates the natural breast and the muscle activation required to extract milk therefrom. The encompassing of the foam within the flexible skin ensures that the device is easier to use and clean as no milk contacts the foam and hence cannot get lodged or stuck therein. This further ensures that the skin is the only component which must be food grade and/or medically approved as the milk will not contact the foam during use. This allows a greater variety of foams to be used, in particular those where it is difficult to obtain food grade and/or medical approval given the lack of certifications issued by manufacturers of foam.

The flexible skin may be formed of first and second bonded segments, the first segment extending around an outer surface of the compressible material and the second section extending around an inner surface of the compressible material. This is a convenient and effective way to enclose the compressible material.

The inner surface of the flexible skin may be arranged in a conical shape defining the milk flow pathway. This is a convenient and effective way to shape of the milk flow pathway.

The flexible skin may be a single integral piece of material. This can simplify the manufacturing process

The flexible skin may further comprise a neck portion, and the neck portion is received by the bore of the compressible material. This locates the flexible skin and the compressible material easily.

An outer surface of the breast portion may be substantially dome shaped, in particular preferably substantially breast shaped. This further reduces any nipple confusion for an infant feeding from the teat.

The dome or breast may have a radius of at least 2 cm, preferably at least 3 cm. These are suitable sizes for typical baby bottles and provide a suitable shape to simulate a breast. The compressible material may be a solid. Solids such as an expanded foam or a silicone may be particularly suitable to simulate a breast.

The skin may be formed of a silicone. Silicone is particularly suitable as it is readily available in food-grade compositions and has similar mechanical properties to human skin. The compressible material may be a solid. The compressible material may be an expanded foam or a silicone. These materials may have similar mechanical properties to the underlying tissue of a human breast.

The compressible material may have a Shore OO of between 45 to 70. This range may be most similar to a human breast's mechanical properties.

The nipple portion may be less compressible than the compressible material. This further reduces nipple confusion as the woman's nipple is relatively harder than the breast tissue.

The flexible skin may be formed of first and second bonded segments, the first segment extending around an outer surface of the compressible material and the second section extending around an inner surface of the compressible material. This is a simple method to manufacture the teat and enclose the compressible material.

The inner surface of the flexible skin may be arranged in a conical shape defining the milk flow pathway. This may allow the amount of compressible material to be minimised, as a void is provided in the central region of the teat, for the milk to flow through.

The portion of the milk-flow pathway which extends through the nipple portion may be a through bore through a generally solid nipple portion. This may reduces the risk of the milk-flow pathway collapsing and more-accurately imitate a nipple during breastfeeding.

An angle may be defined between the breast portion and the attachment means, wherein the angle may be acute. This results in the breast portion overhanging the attachment means, which may form a more rounded shape similar to a natural breast.

An angle may be defined between the breast portion and the nipple portion, wherein the angle may be obtuse. This is a convenient and effective configuration to further reduce nipple confusion as provides substantially the entire nipple protruding from the breast portion This also may allow for a better imitation of the interface between a natural breast and nipple.

The compressible material may be formed as a single piece of material with a bore for receiving the flexible skin. This provides a substantially uniform breast portion similar to natural breast tissue.

The compressible material may be formed generally in a crenellation or castellation shape. This may reduce any regions of overlapping of compressible material, providing a substantially uniform breast portion thickness. This helps in folding a generally flat compressible material into the domed space of the breast portion.

The compressible material may be formed of a central region, with a plurality of spaced protrusions extending therefrom. This may reduce any regions of overlapping of compressible material, providing a substantially uniform breast portion thickness. This helps in folding a generally flat compressible material into the domed space of the breast portion.

The flexible skin may further comprise a neck portion, and the neck portion is received by the bore of the compressible material. This ensures the flexible skin is secured through the compressible material, while providing an effective way to manufacture the teat.

The neck portion may be defined between the inner surface and the outer surface of the flexible skin. This provides a teat similar to a natural breast, and allows for simple manufacture by bonding the inner and outer surfaces in the neck portion.

The compressible material and/or breast portion may have a thickness in the region of 5 millimetres to 20 millimetres. This is to provide a breast portion of a thickness that will be suitable to provide the infant an effective latch, while also effectively mimicking the breast.

A method of manufacturing a teat for a milk bottle is provided according to claim 27 and clause 10.

A further teat for a milk bottle is provided according to claim 28 and clause 11.

The portion of the milk-flow pathway which extends through the nipple portion may have a diameter no greater than 20% of the maximum diameter of the nipple portion, preferably no greater than 10%, most preferably no greater than 5%. Alternatively, or additionally, the portion of the milk-flow pathway which extends through the nipple portion may be a through bore through a generally solid nipple portion. This relatively thick nipple portion ensures that it is suitably rigid so as to more closely mimic a human nipple during breastfeeding.

The nipple portion may be at least an upper 0.5 centimetres of the teat, preferably at least an upper 1 centimetre of the teat. This is similar in size to a human nipple, thereby further reducing nipple confusion.

The teat may further comprise a flexible skin fully enclosing the compressible material and separating the compressible material from the milk-flow pathway. This ensures that the skin is the only component which must be food grade approved as the milk will not contact the foam during use as discussed above in relation to the first embodiment.

The nipple portion may be formed as a thick segment of the flexible skin, the portion of the milk-flow pathway extending through the nipple portion formed as a bore through the thick segment of the flexible skin. This is a convenient way to form the nipple portion compared to connecting separate components.

The nipple portion may be formed of a material having a shore A hardness of 15 to 30. This is similar to the human nipple during breastfeeding.

The flexible skin may be formed of first and second bonded segments, the first segment extending around an outer surface of the compressible material and the second section extending around an inner surface of the compressible material. This is a simple method to manufacture the teat and enclose the compressible material.

The inner surface of the flexible skin may be arranged in a conical shape defining the milk flow pathway. This may allow the amount of compressible material to be minimised, as a void is provided in the central region of the teat, for the milk to flow through.

The portion of the milk-flow pathway which extends through the nipple portion may be a through bore through a generally solid nipple portion. This may reduces the risk of the milk-flow pathway collapsing and more-accurately imitate a nipple during breastfeeding.

An angle may be defined between the breast portion and the attachment means, wherein the angle may be acute. This results in the breast portion overhanging the attachment means, which may form a more rounded shape similar to a natural breast.

An angle may be defined between the breast portion and the nipple portion, wherein the angle may be obtuse. This is a convenient and effective configuration to further reduce nipple confusion as provides substantially the entire nipple protruding from the breast portion This also may allow for a better imitation of the interface between a natural breast and nipple.

The compressible material may be formed as a single piece of material with a bore for receiving the flexible skin. This provides a substantially uniform breast portion similar to natural breast tissue.

The compressible material may be formed generally in a crenellation or castellation shape. This may reduce any regions of overlapping of compressible material, providing a substantially uniform breast portion thickness. This helps in folding a generally flat compressible material into the domed space of the breast portion.

The compressible material may be formed of a central region, with a plurality of spaced protrusions extending therefrom. This may reduce any regions of overlapping of compressible material, providing a substantially uniform breast portion thickness. This helps in folding a generally flat compressible material into the domed space of the breast portion.

The flexible skin may further comprise a neck portion, and the neck portion is received by the bore of the compressible material. This ensures the flexible skin is secured through the compressible material, while providing an effective way to manufacture the teat.

The neck portion may be defined between the inner surface and the outer surface of the flexible skin. This provides a teat similar to a natural breast, and allows for simple manufacture by bonding the inner and outer surfaces in the neck portion.

The compressible material and/or breast portion may have a thickness in the region of 5 millimetres to 20 millimetres. This is to provide a breast portion of a thickness that will be suitable to provide the infant an effective latch, while also effectively mimicking the breast.

A teat assembly for a milk bottle is also provided according to claim 29 or clause 18. This provides a more similar mechanical response and feel during the suckling motion of an infant by inhibiting milk from being returned to the bottle.

The one-way valve may be formed as a slit in a flexible material. This is a simple way to form the valve.

The flexible material may be supported by a rigid frame. This ensures that the valve returns to the correct shape to control milk flow in the intended manner.

The teat of the teat assembly may be according to any of claim 1 to 26 or 28. This combines the benefits discussed in relation to these teats with the benefits of the one-way valve.

The present invention further provides an assembly according to claim 33 or clause 22.

The present invention further provides a kit according to claim 34 or clause 23.

The present invention further provides a top according to claim 35. This securely grips and retains the teat, for attachment to a milk bottle. The teat may be according to any of claim 1 to 26 or 28. Of course, the top may be used with any teat with an outward flange.

The first body component may comprise a threaded portion for attaching to a corresponding threaded portion on the milk bottle.

The top may further comprising a third body component, arranged between the teat and one of the first body component or the second body component, preferably the third body component is an annular ring corresponding to the radial flange of the teat. The third body component can help prevent the risk of the teat being twisted as the screw top is attached to the teat or to a milk bottle by equalising the twisting forces.

The radial flange may comprises one or more grooves, and one or more of the body components may comprise one or more protrusions for receipt in the one or more grooves to grip the radial flange and retain the teat. The protrusions help the top to grip the flange securely in the grooves.

A teat for a pacifier (also known as a dummy, soother or teether) is provided according to clause 24 or claim 39 and a pacifier is further provided according to clause 25 or claim 40. This teat for a pacifier more accurately simulates the natural breast and hence avoids confusing the infant. Further, this can help prevent malocclusion caused by conventional pacifier teats.

The present invention further provides a one-way valve according to claim 41 or clause 26. This is a simple, but effective one-way valve that provides a reliable seal. In particular, this valve may be mounted on the bottom of a milk bottle and thereby selectively allow air to enter the milk bottle as it is tilted to help prevent an infant from ingesting air and hence developing colic. This valve may be used with any bottle or teat discussed in the present application.

The valve element may a ball valve element, preferably a ball bearing. This is a reliable arrangement, and the valve elements may be mounted in a cage for easy operation of the valve.

A guide may be provided in the one-way valve, the guide shaped to direct the first valve element towards the first valve seat. This guide can direct the ball towards the first valve seat, thereby preventing the valve opening before the bottle is turned through a particular threshold, such as 90° from a standing position.

The guide may be provided as a part of the first valve seat. This is a convenient way to provide and arrange the guide.

The valve may further comprise a second ball valve element arranged adjacent the first ball valve element. This increases the weight applied to deform the first valve seat.

The guide may be formed as a concave section for receiving the first valve element.

The or each valve element is unbiased. That is, there may be no spring or other biasing member forcing the valve elements towards the valve seat. Thus, the valve elements are solely forced towards the valve seat via gravity. This allows for simple and effective actuation of the valve.

The or each valve element may be retained within a cage, the valve element freely moveably within the cage. This is an effective way to allow the valve elements to move under gravity towards and away from the valve seat.

The cage may comprise one or more projections arranged to restrict movement of the or each valve element away from the first valve seat. In this sense, the movement of the valve element away from the first valve seat may be restricted to less than 3 mm. This restricted movement helps prevent the valve element from become submerged, and hence prevents leaking through the valve.

The cage may be deformable for forcing the or each valve element beyond the one or more projections. This allows the valve element to be forced beyond the projections, so as to allow for cleaning and/or servicing of the valve.

The one-way valve may further comprise a bottom for attaching to a milk bottle, wherein the cage is retained by the bottom, further comprising a compressible flange arranged between the cage and the milk bottle for sealing therebetween. This is a simple and effective way to form the one-way valve without allowing leakage.

The first valve seat may comprise the compressible flange. That is, the flange may be formed integrally as a one-piece valve seat. This further simplifies the design of the one-way valve.

The one-way valve may further comprise an occluding member between the first valve element and the first valve seat, the occluding member moveable under the weight of the first valve element to sealingly engage the first valve element and the first valve seat. The occluding member improves the seal between the valve element and the valve seat.

The occluding member may be formed as: a flap extending from the first valve element; or a freely moveable membrane. These are effective ways of forming the occluding member.

The present invention further provides an assembly according to claim 55. The teat of the assembly may be according to any of claim 1 to 26 or 28.

### BRIEF DESCRIPTION OF THE DRAWINGS

The present invention will now be described, by way of example only, with reference to the accompanying figures in which:

FIG. 1 shows a perspective view of a teat according to the present invention;

FIG. 2 shows a further perspective view of the teat of FIG. 1;

FIG. 3 shows a bottom view of the teat of FIG. 1;

FIG. 4 shows a cross-sectional schematic of the teat of FIG. 1;

FIG. 5 shows a perspective view the teat of FIG. 1 in a partially disassembled state;

FIGS. 5A, 5B and 5C shows a top view of exemplary shapes for a compressible material.

FIG. 6 shows a side view of the partially disassembled teat of FIG. 5;

FIG. 6A shows a top perspective view of the compressible material with a neck portion received in a bore.

FIG. 6B shows a bottom perspective view of the compressible material with the neck portion received in the bore.

FIG. 7 shows a side view of the teat of FIG. 1 in a further partially disassembled state, with further components disassembled to FIG. 5;

FIG. 8 shows a top view of the further partially disassembled teat of FIG. 7;

FIG. 9 shows a perspective view of an assembly of the teat of FIG. 1 attached to a milk bottle top;

FIG. 10 shows a lower view of the assembly of FIG. 9;

FIG. 11 shows a cross-sectional schematic of an alternative teat according to the present invention;

FIG. 12 shows a perspective view of a non-return valve for use with the teat of FIG. 1;

FIG. 13 shows a lower view of the non-return valve of FIG. 12;

FIG. 14 shows a perspective view of the non-return valve of FIG. 12 in a disassembled state;

FIG. 15 shows a lower view of the non-return valve of FIG. 12 in the disassembled state of FIG. 13;

FIG. 16 shows a further assembly with the non-return valve of FIG. 12 inserted into the assembly of FIG. 9;

FIG. 17 shows another assembly of the teat of FIG. 1 combined with the non-return valve of FIG. 12 attached to an infant milk bottle;

FIG. 18 shows a bottom perspective view of the assembly of FIG. 17;

FIG. 19 shows an exploded view of an infant milk bottle and a first one-way air valve;

FIG. 20 shows an exploded view of a bottom portion of the infant milk bottle and the one-way air valve of FIG. 19;

FIG. 21A shows a cross-sectional view of the one-way air valve of FIG. 20 in a rest state;

FIG. 21B shows a cross-sectional view of the one-way air valve of FIG. 20 in an actuation state;

FIG. 22 shows a cross-sectional view of the one-way air valve of FIG. 20 in an intermediate state;

FIG. 23 shows a cross-sectional view of the one-way air valve of FIG. 20 in a service state;

FIG. 24 shows an cross-sectional view of a the one-way air valve of FIG. 20 attached to a bottom of a milk bottle;

FIG. 24A shows an enlarged section from FIG. 24;

FIG. 25A shows an enlarged cross-sectional view of a further one-way air valve in an actuation state;

FIG. 25B shows an enlarged cross-sectional view of a the one-way air valve of FIG. 25A in a rest state;

FIG. 26A shows an enlarged cross-sectional view of a further one-way air valve in an actuation state;

FIG. 26B shows an enlarged cross-sectional view of the one-way air valve of FIG. 26A in a rest state;

FIG. 27 shows an exploded view of another one-way air valve as shown in the assembly of FIG. 17;

FIGS. 28A and 28B show the one-way air valve of FIG. 27 in a closed and open position respectively;

FIG. 29 shows a perspective view of a teat according to the present invention incorporated into a pacifier; and

FIG. 30 shows a cross-sectional view of the pacifier of FIG. 29.

FIG. 31 shows an exploded view of the teat with an alternative screw top assembly formed of a first, a second and a third body components.

FIG. 32 shows a side cross-sectional view of the teat and the multi-part screw top assembly of FIG. 31.

FIG. 32A shows an enlarged cross-sectional view of the teat and the multi-part screw top assembly of FIG. 32.

### DETAILED DESCRIPTION

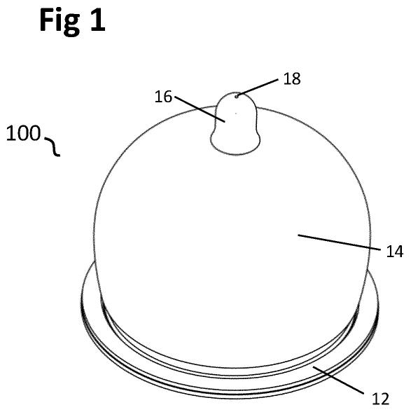

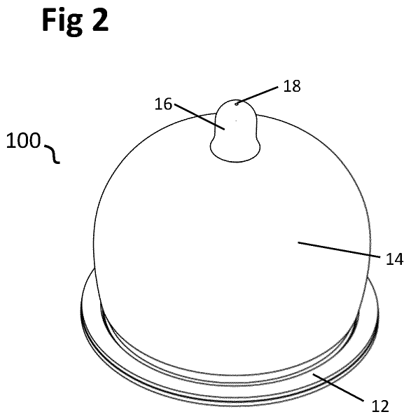

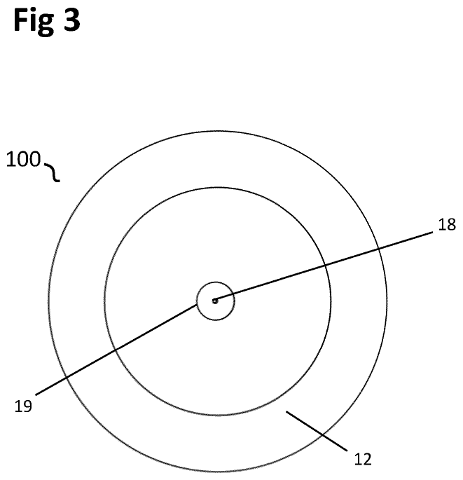

FIGS. 1 to 4 show a teat 100 according to and incorporating aspects of the present invention. The teat 100 is generally dome shaped. In particular, the teat 100 is generally breast shaped in order to more closely mimic the shape of a human breast. The teat 100 comprises an attachment portion 12. The attachment portion 12 of the depicted embodiment consists of a radially extending flange which can be retained by a bottle top portion which attaches to a milk bottle, for example by screwing onto a threaded portion of a milk bottle. The milk bottle may be any suitable bottle for an infant, and may be filled with any fluid, not just milk. The attachment portion 12 may however be any suitable means for attaching the teat 100 to a milk bottle. Preferably, the attachment portion 12 is a generic attachment means which can interact with any generic milk bottle available commercially. Alternatively, the attachment portion 12 may be specific to a proprietary milk bottle.

Extending from this attachment means 12 is a breast portion 14. This breast portion 14 is the primary generally dome shaped portion intended to closely mimic the human breast. In some embodiments, it may be preferable for an angle formed between the section of the breast portion 12 extending from the attachment means 12 to be an acute angle. This may result in the breast portion 14 having an overhang, where its outer diameter increases in the direction away from the attachment means 12. It may be more preferable that the largest diameter of the breast portion 14 is larger than an inner diameter of the attachment means 12.

A nipple portion 16 then extends from this breast portion 14. The nipple portion 16 is also preferably dome shaped and generally arranged to mimic a human nipple during breastfeeding. In some embodiments, it may be preferable for a portion extending from the breast portion 14 to the nipple portion 16 to have a positive angle. Most preferably, the angle defined between the breast portion 14 and the nipple portion 16 is an obtuse angle, this provides a smooth transition from the nipple portion 16 to the breast portion 14, as well as providing a correct anatomic profile to prevent nipple confusion. In this embodiment, it may be more preferable that the obtuse angle is greater than 115 degrees. The nipple portion 16 further comprises an outlet 18. In use, the infant's mouth will extend around the nipple portion 16 and a section of the breast portion 14 and milk will be expelled from the outlet 18 for the infant to consume. In particular embodiments, more than 30% of the outer surface area of the breast portion 14 may be received within the infant's mouth, preferably more than 50%.

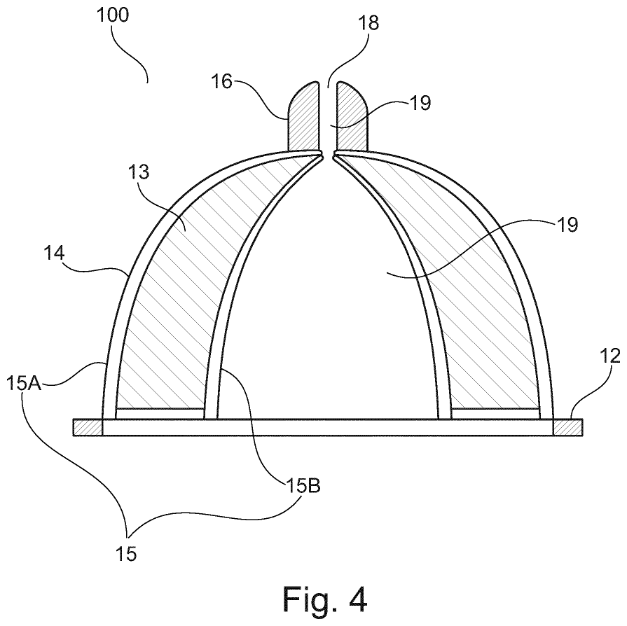

As best shown in FIG. 4, the breast portion 14 is formed of a flexible skin 15 which fully encloses a compressible material 13. The compressible material 13 may be, in any embodiment, an elastically deformable material. That is, a material which returns to substantially the original shape after the compressing force is removed. In particular embodiments, the flexible skin may comprise an outer flexible skin 15a in which extends across an outer face of the compressible material 13 and an inner flexible skin 15b which extends across the inner face of the compressible material 13. The outer flexible skin 15a is outermost of the teat 100 and is the portion of the flexible skin 15 that the infant will contact in order to latch onto the teat 100. The outer and inner faces 15a, 15b may be separate faces which are bonded together during manufacture. Alternatively, the outer and inner faces 15a, 15b may parts of a single integral sheet of flexible material 15. Each of the flexible skins 15a, 15b may have a thickness in the region of 0.5 millimetres to 5 millimetres.

The inner flexible skin 15b may generally form a conical shape when the teat 100 is assembled. That is, the inner flexible skin 15b may bound a volume which is generally conical. The bounded volume may be left generally empty in the assembled teat 100 and form the milkflow pathway 19. The dimensions of the bounded volume may be selected for particular characteristics of the teat. For example, a larger bounded volume may make the teat 100 more flexible and therefore be suitable for smaller infants or babies with limited suction power, such as prematurely born babies. The bounded volume may have a maximum dimension at a bottom portion of the assembled teat in the region of 30 millimetres to 60 millimetres. The bounded volume may have a minimum dimension at a top of the assembled teat in the region of 5 millimetres to 20 millimetres.

The compressible material 13 is selected to have a compressive resistance similar to a human breast. Preferably, the compressible material is a solid, and not a liquid or a gas as these may leak from the teat 100 if it is punctured. In particular, the compressible material 13 is selected to have similar mechanical and elastic properties as the breast tissue. For example, the compressible material 13 may be an open cell foam material such as a sponge. Suitable materials may include one or more of polyurethane foam, polyether foam, silicon in the form of rubber or foam, natural sponge, gel foam, polyethylene foam, ethylene copolymer foam, expanded polystyrene foam, expanded polyethylene foam, fluoropolymer foam, polyester foam, polyetherimide foam, polyolefin foam, hydrogels, rubbers and elastomers either synthetic or natural. The compressible material acts to sustain the outer shape of the teat 100 to allow a suitable consistency for the infant to establish a latch. That is, the compressible material is not substantially compressed during use as it would be by a “chewing” action.

The compressible material 13 may have a thickness in the region of 5 millimetres to 20 millimetres. This thickness may be measured when no compression force is applied to the compressible material 13. This thickness may be generally maintained when the compressible material 13 is incorporated into the teat 100. That is, the breast portion 14 may have a thickness in the region of 5 millimetres to 20 millimetres.

“Synthetic Rubber” is intended to mean any artificial elastomer. Typically, these are polymers synthesised from petroleum byproducts. Exemplary synthetic rubbers include styrene-butadiene copolymer, nitrile rubber, neoprene, ethylene-propylene-diene-monomer rubber, silicon rubber and butyl rubber.

“Natural Rubber” is intended to mean a rubber obtained from non-petroleum sources. Typically, natural rubber is a biosynthetic polymer obtained from a tree called “Hevea brasiliensis” as an aqueous solution. Natural rubber is mainly poly-cis-isoprene containing typically up to about 5 wt % of other materials such as protein, fatty acids, resins and inorganic salts.

The compressible material 13 may be a hyper-elastic solid as breast tissue is often modelled as such a solid. In particular, the compressible material 13 may be a foam with a Shore OO hardness of 45 to 70. Alternatively, the compressible material 13 may be a rubber with a shore A hardness of 15 to 30.

The thin skin layer 15 then mimics the human skin. In particular embodiments, the thin skin layer 15 may be a silicon layer. Alternatively, the skin layer 15 may be any elastomeric material with similar mechanical properties to human skin. This includes polyurethane, polyisoprene, and polybutadiene. The skin layer 15 may have a thickness of between 0.8 millimetres to 2 millimetres in the breast portion 14 of the teat 100. The elastomeric material forming the skin layer 15 may have a shore A hardness value of 15 to 30.

A milk flow pathway 19 is thus defined which extends from the attachment portion 12 to the bottle through to the outlet 18 of the nipple portion 16. Milk exiting the teat 100 will pass along this flow path 19. The compressible material 13 is fully separated from the milk flow path 19 by virtue of the flexible skin 15, providing a through bore of the compressible material 13.

In particular, in the breast portion 14 of the teat 100, the inner section of flexible skin 15b defines the milk flow path. In particular embodiments, the milk flow pathway 19 includes a conical shape. The conical shape of the milk flow pathway is defined by the inner section of flexible skin 15b. The conical shape may extend over the majority of the length of the milk flow pathway, and/or the majority of the length of the breast portion 14. In a preferred embodiment the conical shape varies in gradient as it traverses from the attachment means 12 to the inlet of the nipple portion 16. Most preferably the milk flow pathway 19 from immediately before the inlet of the nipple portion 16 is a conical shape that expands into a cylindrical section. The cylindrical section may be in fluid communication with a through bore in the nipple portion 16, thus providing a means of aligning the compressible material 13 and a passage of uniform separation of the compressible material 13.

The nipple portion 16 may be less compressible than the compressible material 13. In particular, the nipple portion 16 may have a Shore A hardness value of 15 to 30. In particular embodiments, the nipple portion 16 may be formed as a solid component. That is, the nipple portion 16 may be provided as a mass of silicone, with no compressible material provided therein. The nipple portion 16 may have a through bore formed therein to form a portion of the milk flow pathway 19. This may be a solid amount of the material for the flexible skin 15, such as silicone. The nipple portion 16 may be formed integrally with the flexible skin 15, such as with one or both of the outer flexible skin 15a and/or the inner flexible skin 15b

The nipple portion 16 may be configured to prevent the milk flow pathway 19 from collapse when the infant provides a suction, pump-like, action on the teat. The difference in Shore hardness of the nipple portion 16 compared to the breast portion 14 with the compressible material 13 allows a pump like mechanism of milk extraction through the milk flow pathway 19 and the nipple portion outlet 18. This action is more similar to breastfeeding. While the breast portion 14 and the nipple portion 16 may be formed of the same material, with the same hardness as a property, is the overall hardness of the region that is important. That is, because the nipple portion 16 may be generally solid compared to the breast portion 18. This results in the breast portion 18 being more malleable and hence having an overall lower Shore hardness as a portion, despite the materials having the same Shore hardness.

The milk-flow pathway 19 in the nipple portion 16 may have a diameter which is no greater than 20% of the diameter of the nipple portion, preferably no greater than 10%, most preferably no greater than 5%. In particular embodiments, the milk pathway may have a diameter of between 0.2 millimetres to 0.5 millimetres. In some of these embodiments the nipple portion 16 may have a diameter of approximately 10 millimetres and hence the milk pathway has a diameter of between 2% to 5% of the diameter of the nipple portion 16. These diameters are defined generally in a direction transverse or perpendicular to the milk-flow pathway 19. The nipple portion 16 may be an upper 0.5 cm of the teat 100, preferably an upper 1 cm of the teat 100. The “upper” direction is defined in the direction of milk-flow from the bottle to the infant. That is, the upper part is the region the infant latches to in use.

Recent studies such as Biomechanics of Milk Extraction During Breastfeeding by Elad et al., the entire contents of which is hereby incorporated by reference, have characterised the breastfeeding motion in great detail. In order for the infant to affectively extract milk from the breast, they first must establish a latch on a wide area of the breast. Following this latch, they develop a sub-atmospheric pressure within their mouth. This in turn deforms the breast tissue in the latch region in order to adjust it to the contours of the infant's mouth and tongue. The extraction of milk is then caused by a pressure gradient that is generated in the infant's mouth by varying the volume of the infant's mouth. Essentially, the infant rhythmically opens and closes the mouth in a motion similar to chewing. This varies the mouth volume and hence encourages milk from the breast. This varying of mouth volume is mostly caused by the masseter muscle discussed above in the background to the invention. The use of the compressible material 13 and flexible skin 15 of the present invention allows this action to be affectively mimicked by the infant when bottle feeding. In particular, as the material and shape of the teat 100 more precisely matches the mechanical properties of the human breast, the same action is possible to extract milk from the bottle. The harder nipple portion 16 also allows the teat 100 to be more similar to a breast.

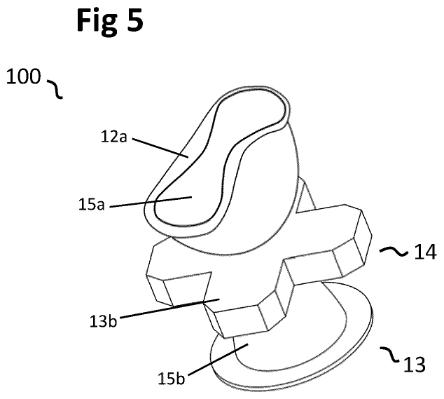

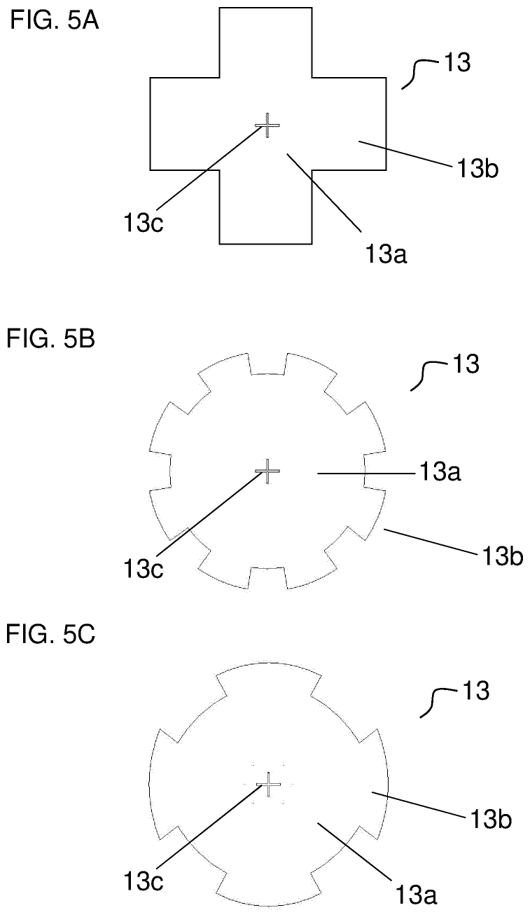

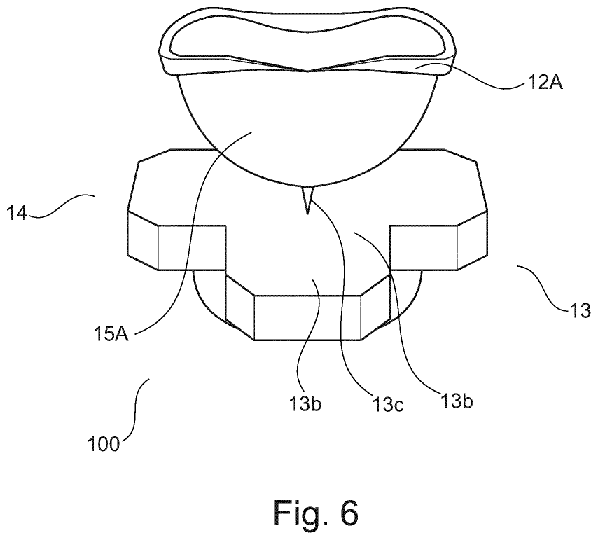

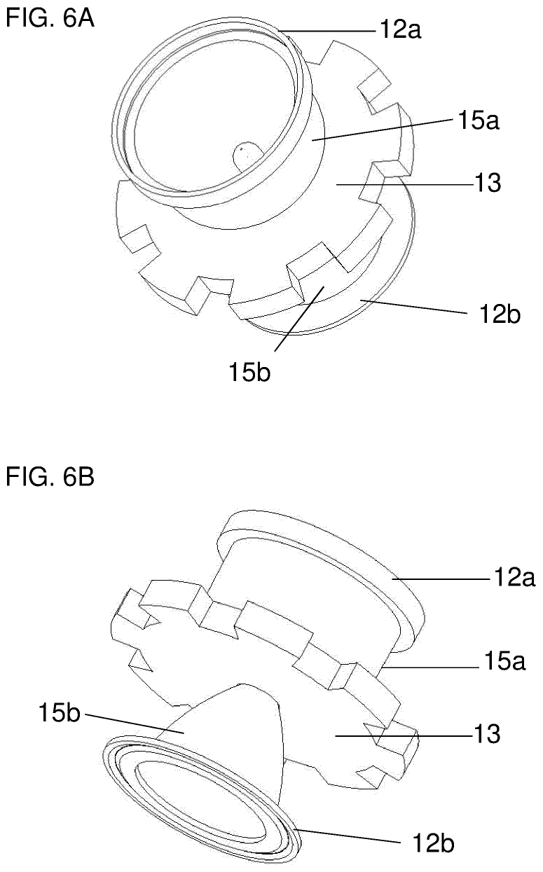

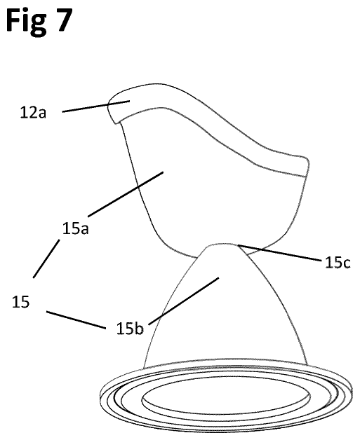

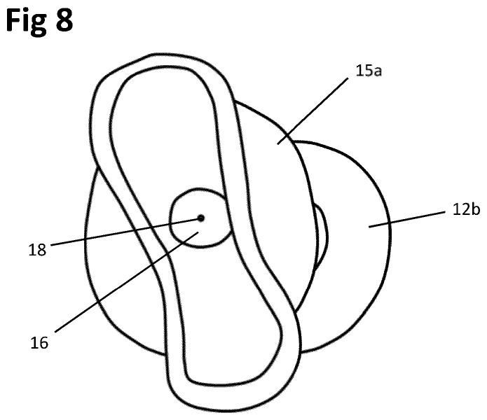

FIGS. 5 to 8 show how the compressible material 13 is affixed and enclosed within the flexible skin 15 to form the teat 100. As shown in FIG. 7, the first and second sections of the flexible skin 15 narrow towards a neck portion 15c. The nipple portion 16 then extends from this neck portion 15c. The milk-flow pathway 19 passes through an interior of this neck portion 15c. The compressible material 13 is then provided between these first and second skin segments as shown in FIGS. 5 and 6. The compressible material 13 may be provided as a single piece of material for the entire teat 100, such as a slab of material.

The slab of material may be cut or shaped into an appropriate shape for the compressible material 13.

In the particular embodiment of these Figures, the compressible material 13 is a foam and is formed generally in the shape of a cross or plus symbol as shown in FIG. 5. Preferably the compressible material 13 is formed generally in a crenellation or castellated shape. Potential exemplary shapes for the compressible material are shown in FIGS. 5A to 5C. That is, the compressible material 13 may be formed of a central region 13a, with a plurality of spaced protrusions 13b extending therefrom. The spaced protrusions 13b may be distributed around the central region 13a, for example with rotational symmetry. The spaced protrusions 13b may be any suitable shape, such as merlon shaped.

The compressible material 13 may have a bore 13c for receiving the neck portion, as best shown in FIGS. 5A to 5C and FIG. 6. This bore 13c may be formed as a cut through the compressible material 13. For example, the bore 13c may be formed in a cross shape or any other suitable shape. FIGS. 6A and 6B show the compressible material 13 with the neck portion received in the bore 13c.

This is to allow the foam to effectively fill the required space without generating undesired lumps. Each of the first and second sections of the flexible skin 15 includes first and second flange portions 12a and 12b which bond together to enclose the flexible material 13 and provide the attachment portion 12. As such, the compressible material 13 is entirely sealed away from the milk flow pathway 19. The first and second flange portions 12a, 12b may be bonded together to enclose the flexible material. For example, the silicone flange portions 12a, 12b may be bonded with an acetate-based silicone adhesive.

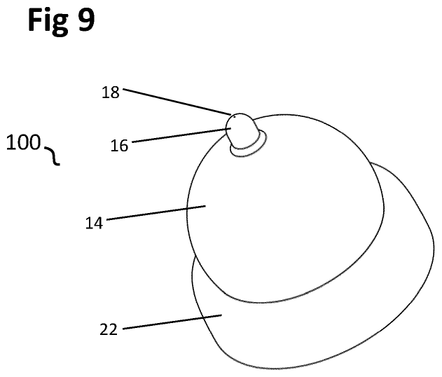

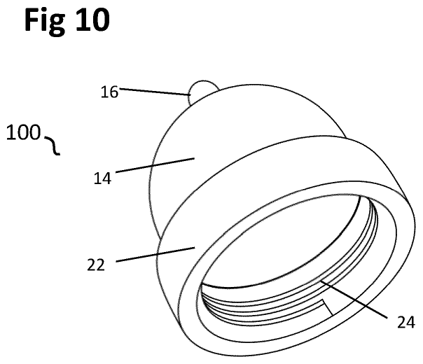

FIGS. 9 and 10 show the teat 100 retained within a screw-top 22 for a milk bottle. The screw top lid 22 includes an inner threaded portion 24 for attaching to an outer threaded portion of a milk bottle (not shown). The screw top 22 includes an opening at its upper end into which the teat 100 is inserted from below. This opening then retains the attachment portion 12 of the teat 100 as shown in FIGS. 9 and 10. This assembly of screw top portion 22 and teat 100 is then ready to be attached to a milk bottle.

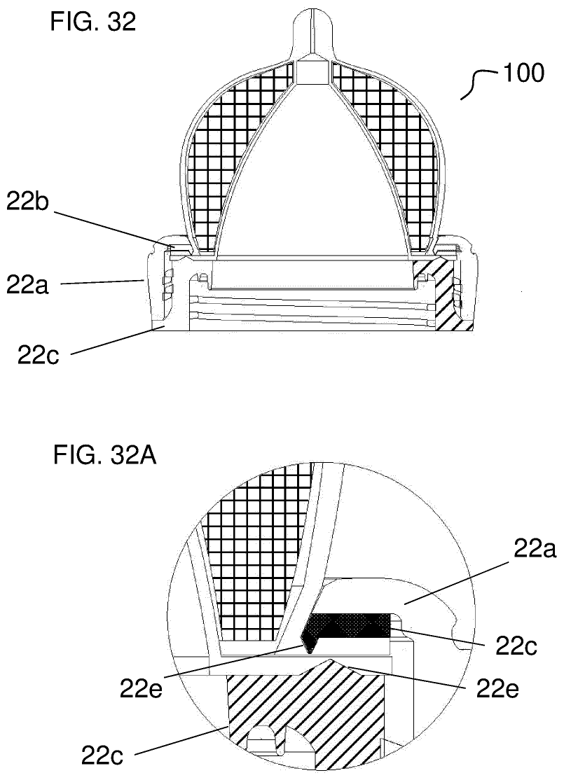

In alternative embodiments, the screw top 22 may be formed of one or more body components which interact to retain the teat 100. For example, as shown in FIGS. 31 to 32A the screw top 22 may be formed of first 22a, second 22c and third 22b body components which are attachable to one another to thereby press the flange portions 12a and 12b together and retain the teat 100. The first body component 22a may be attachable to the second body component 22c via a mechanical attachment, for example via correspondingly threaded portions or via a press-fit. As the first body component 22a is attached to the second body component 22c, the teat 100 may be gripped and retained between these two body components 22a, 22c. This is the simplest arrangement of the multi-part screw top 22. It is not necessary in all embodiments to further include the third body component 22b.

The third body component 22b may generally align with the flange portion 12a. This third body component 22b may be retained between the flange portion 12a and the first body component 22a. The third body component 22b can then help equalise the twisting forces applied to the teat 100. This helps prevent the risk of the teat 100 being twisted as the screw top 22 is attached to the teat 100 or to a milk bottle. The twisting of the teat 100 could result in the milk flow pathway 19 collapsing.

The third body component 22b may be a generally annular component that corresponds to the dimensions of the flange portion 12a.

The mechanical attachment of the first and second body components 22a, 22c may be configured to provide a tight fit to compress and grip the flange portions 12a, 12b to retain the teat 100. Most preferably in the mechanical attachment of the first and second body components 22a, 22c may provide a watertight seal.

The flange portions 12a, 12b of the teat 100 may include attachment sections for improving the retention and gripping of the teat 100 within the multi-part screw top 22 as shown in FIG. 32A. For example, one or more grooves may be formed therein. The corresponding body component 22a, 22b, 22c will then have a corresponding protrusion 22e. When assembled, the respective protrusion 22e is received in the respective groove. This can create a pinched or bottleneck portion which helps prevent dislodgement of the teat 100 from the multi-part screw top 22.

With the multi-part screw top 22 assembled and retaining the teat 100, this can be attached to a milk bottle by any known means, such as via a threaded connection.

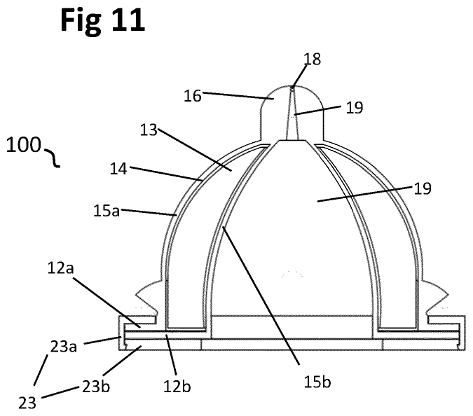

FIG. 11 depicts a schematic cross-sectional view of an alternative embodiment of a teat 100. This teat 100 is generally as described above with respect to FIGS. 1 to 10. However, the flange portions 12A, 12B of the inner and outer skins 15A, 15B are not affixed to one another, or sealed together during manufacture. Instead, the flange portions 12A, 12B are free and are held together by a fixing body 23.

The fixing body 23 may be formed of first 23A and second 23B body components which are attachable to one another to thereby press the flange portions 12A, 12B together. For example, as shown in FIG. 11, the first and second body components 23A, 23B may be attachable via a mechanical lock, such as a press-fit arrangement. These first and second body components 23A, 23B may be fixed together, for example via an adhesive or soldering.

This alternative teat 100 may then be attached to a milk bottle via a screw top lid 22 as described above. In alternative embodiments, the fixing body 23 may be integral to or attachable to the screw top lid 22.

A method of manufacturing the teat 100 is also provided. First, the compressible material 13 is provided. A passage extends therethrough. This passage is then lined by the flexible skin 15 to define the milk-flow pathway 19. The flexible skin 15 encloses the compressible material 13 there-within to form a breast portion 14. Thus the flexible skin 15 separates the compressible material 13 from a milk-flow pathway.

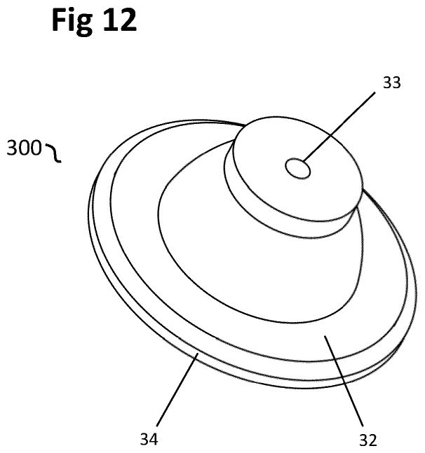

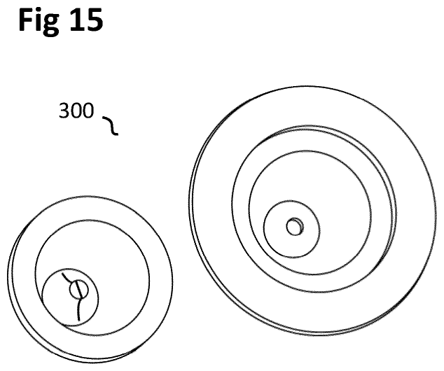

FIGS. 12 to 15 show a one-way valve 300 for use in a milk bottle assembly, in particular it may be used with the teat 100 previously described. The one-way valve 300 is also known as a non-return valve. The valve assembly 300 comprises an outer rigid component 32 and an inner flexible component 34. The outer rigid component 32 includes a central projection 36 which plateaus to a flat section with an opening 33. The inner flexible component 34 has a generally matching shape. In use, the inner flexible component 34 is retained within the outer rigid component 32, with a central projection of the inner flexible component 34 within the central projection 36 of the outer rigid component 32.

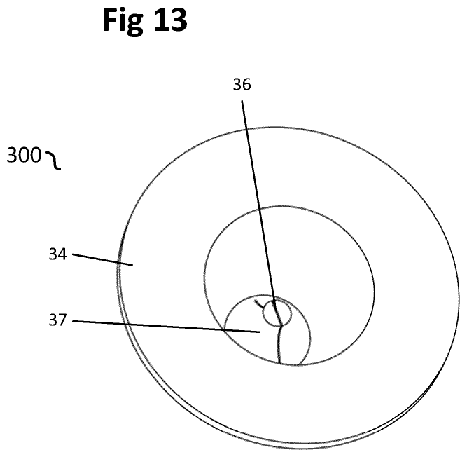

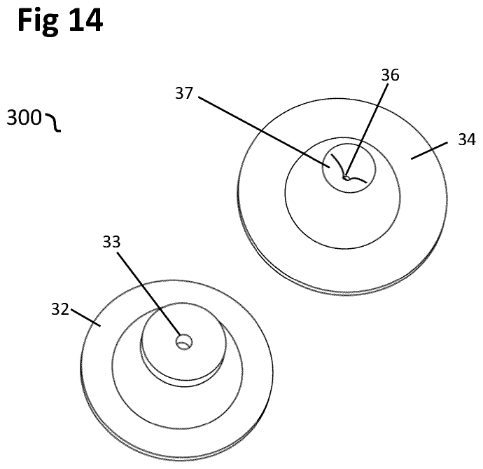

The inner flexible component 34 is best shown in FIGS. 13 and 14 and comprises a corresponding inner projection. This corresponding inner projection extends within the projection of the rigid portion 32 and maintains its shape therein. The top of this inner projection then extends back towards the flat flange of the flexible portion 34 with a slope section 37. At the apex of this slope section 37 is a slit valve 36. That is, the valve 36 is formed as a slit within the flexible material. When the flexible portion 34 is mounted within the rigid portion 32 the assembly 300 then acts as a non-return valve. This non-return valve is mounted within the screw top 22 as shown in FIG. 16.

In alternative embodiments, the valve 300 could be mounted on an opening to a bottle, via the outer flat flange of the rigid portion 32. That is, the flange of the rigid portion would be supported by a rim of the opening. This would be easily removable for filling the bottle or cleaning.

This valve 300 allows milk to flow from the bottle to the teat 100 but not from the teat 100 back into the bottle. This allows the teat 100 to more accurately mimic a human breast where milk cannot flow back into the breast. As such, the teat 100 will have a more realistic feel and mechanical response during the suckling motion of the infant

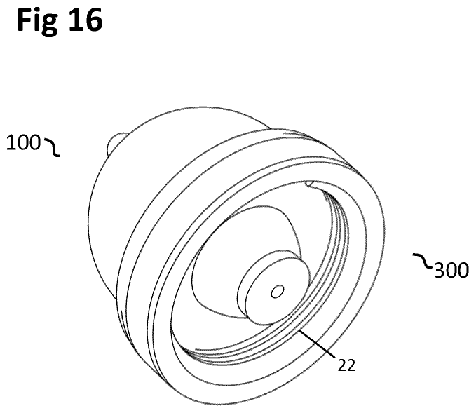

FIGS. 17 and 18 show the teat 100 attached via a screw top 22 to a bottle 42 in an assembled state. This bottle 42 will be filled with milk (or any other liquid) and this is the assembly in which an infant may use the teat 100 for bottle feeding. As milk is expelled from the bottle 42 a vacuum would otherwise form as the empty volume of the bottle 42 where the milk used to be used to be is created. In order to address this it is necessary for the infant to un-latch from the teat 100 to allow air back into the bottle. This is not a desired motion as doing so causes the infant to ingest air and can induce colic in the infant. As such, there is a need to allow air into the milk bottle 42 to prevent this. This further allows the use of the teat 100 to more accurately mimic a human breast as this un-latching is not necessary for a human breast.

In order to achieve this, a one-way air valve 500 is provided within a milk bottle 42. This valve may be any conventional mechanism known to allow air into the milk bottle 44. For example, in one particular embodiment, an inner sleeve may be provided within the milk bottle 43 containing the milk. The air valve 500 may then allow air into the area surrounding this inner sleeve. The inner sleeve is formed of a flexible, deformable, material and hence as the milk leaves the inner sleeve it deforms and shrinks under pressure. Air is allowed into the area surrounding the flexible sleeve to maintain a constant pressure as the milk is drank. The valve 500 in this embodiment does not need to provide any metering or directional control and can be as simple as a hole in the milk bottle.

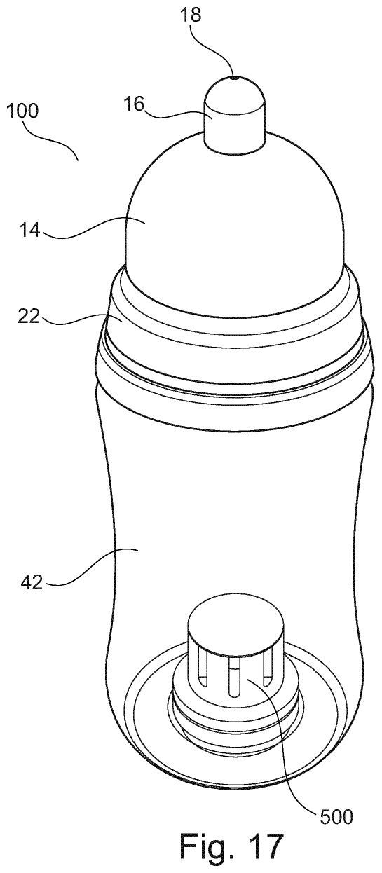

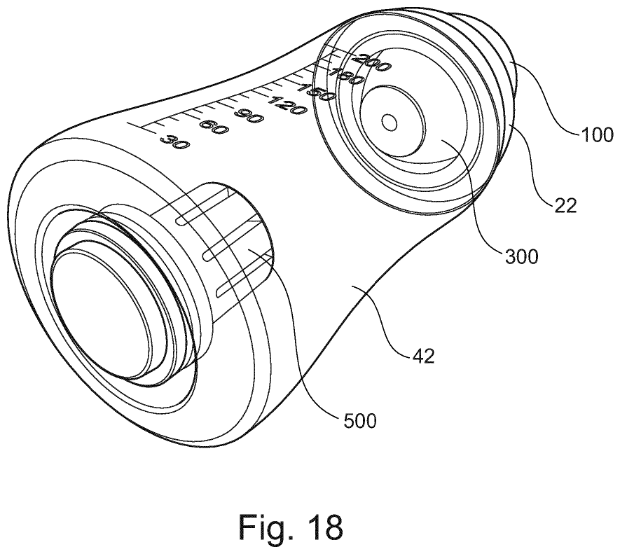

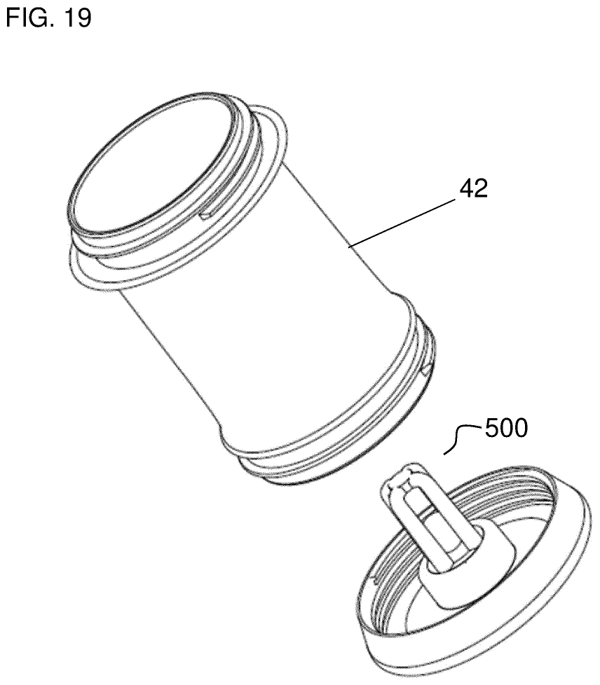

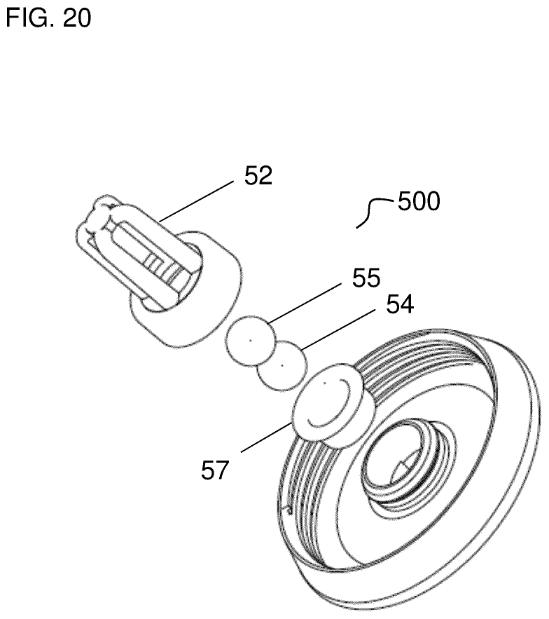

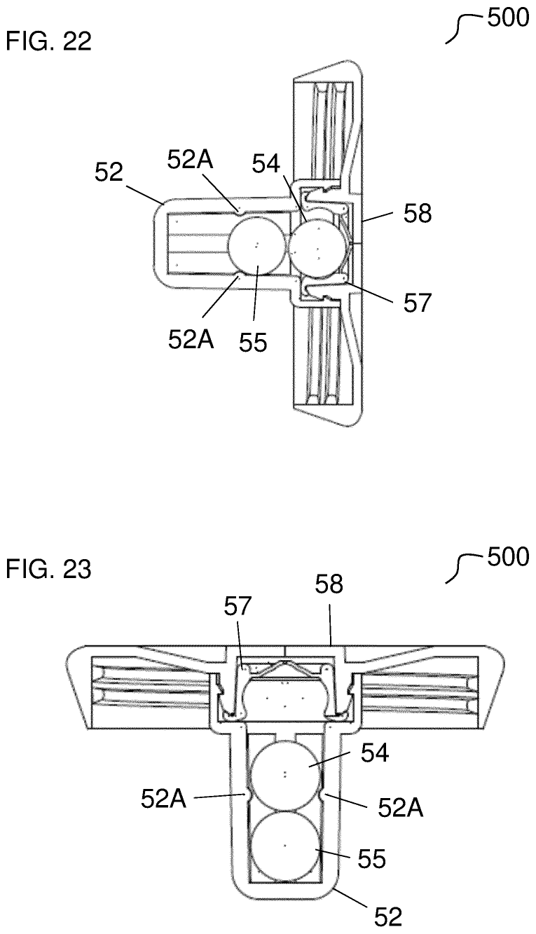

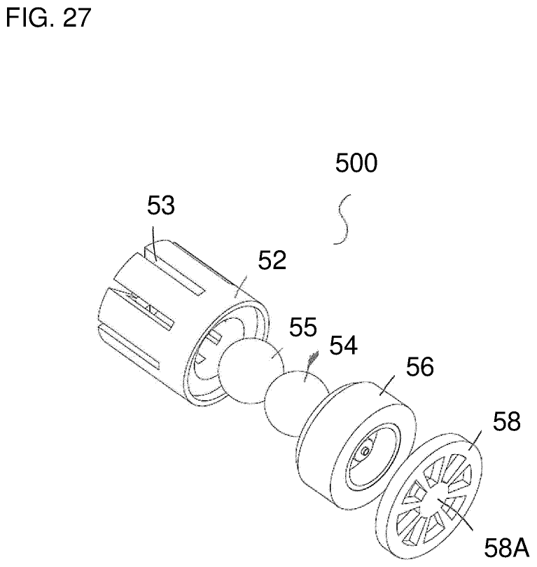

Particular embodiments of the air valve 500 are shown in FIGS. 19, 20, 21A, 21B, 22, 23, 24, 25A, 25B, 26A, 26B, 27, 28A and 28B. The air valve 500 is formed of a valve unit 56 comprising a valve seat 57. A valve element 54 is provided for selectively sealing with the valve seat 57 to seal the air valve 500. The valve element 54 may be any suitable shape, but is preferably a ball valve element 54. When the valve element 54 seals with the first valve seat 57, the weight of the valve element 54 under gravity deforms the first valve seat 57. The first valve seat 57 further includes an opening defining a flow pathway. The opening may be formed as a part of a central projection 59 of the first valve seat 57. Alternatively, the opening may simply be formed as an opening though the first valve seat 57. The first valve seat 57 is moveable under the weight of the valve element 54 to seal with a second valve seat 58A. When the first valve seat 57 seals with the second valve seat 58A, the opening is blocked to prevent fluid flow through the first valve seat 57.

In particular embodiments, a second ball 55 is provided. This provides additional weight to the primary ball valve element 54 to aid in the closing of the air valve 500 under gravity. The ball valve element(s) 54, 55 are retained within a cage 52 that allows them to move a small amount towards and away from the first valve seat 57. The cage 52 comprises a plurality of slots 53 extending therethrough to allow for a passage of air through the valve 500. The cage 52 is attached to the valve unit 56 and extends into the milk bottle.

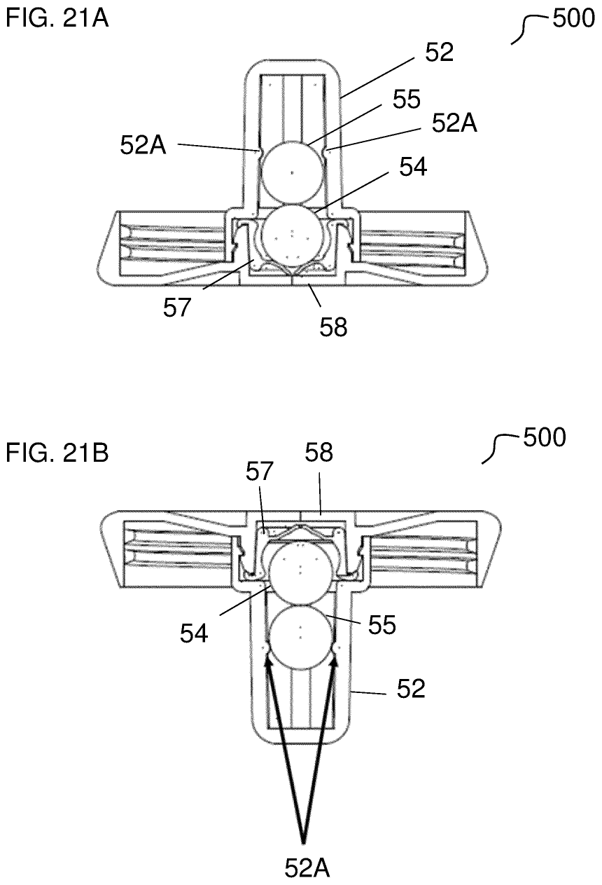

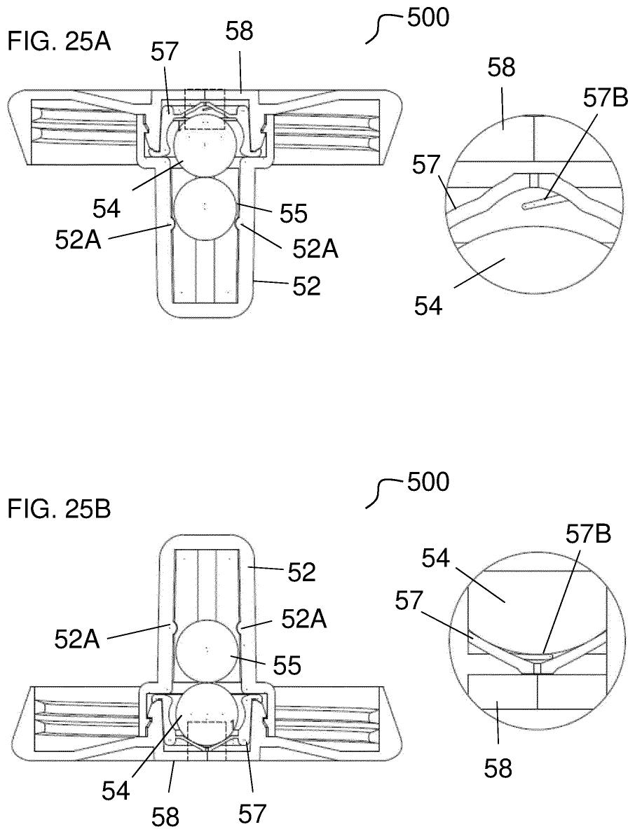

In a resting position, the milk bottle is placed on a surface with its lower end facing downwards (0 degrees of inclination). As the valve 500 is provided on this lower end, the force of gravity acts to bias the ball valve element 54 towards the first valve seat 57 as shown in FIGS. 21A, 25B, 26B &28A, thereby sealing the first valve seat 57 and the valve 500 via the weight of the valve element 54. The force of gravity acts to force the ball valve element 54 to press against the valve seat 57, thus sealing the flow pathway through the central opening as shown in FIGS. 21A, 25B & 26B. As the bottle is lifted and tilted upwards so as to feed the infant, the valve 500 is inverted as shown in FIGS. 21B, 25A, 26A & 28B. As a result, the force of gravity acts to move the ball valve element 54 away from the valve seat, thereby allowing air to flow through the valve 500 into the milk bottle.

The first valve seat 57 is deformable towards the second valve seat 58a, such that the second valve seat 58a seals with the first valve seat 57 to block the opening therein. The first valve seat 57 may be formed as a membrane such as shown in FIGS. 21A to 26B. In particular, the membrane may be a thin portion with a preferable thickness in the range of at least 0.4 mm to 2 mm. The membrane may be a deformable elastic material with a shore hardness in the range of 15 to 40. In the rest position the ball valve element 54 is seals with the membrane. The membrane then deforms under the weight of the ball valve element 54 such that the membrane is moved towards the second valve seat 58A, thus providing first and second seals in the air flow pathway as shown in FIGS. 21A, 25B & 26A.

In an actuated position, the milk bottle lower end face is rotated from facing downwards to a position above the horizontal (90 degrees of inclination) up until a position where the lower end face is facing upwards, (180 degrees of inclination) such that the valve 500 is inverted. In the transition from the rest position to the actuated position the ball valve element 54 moves away from the membrane, thus the membrane moves away from the second valve seat 58A, opening the flow path and allowing air to flow through into the milk bottle. When the valve 500 is inverted, the ball valve element 54 moves away from the membrane, and travels along the cage 52. The cage 52 guides the ball valve element 54 when it moves away from the membrane.

The cage 52 may further comprise one or more projections 52A that are configured to inhibit movement the ball valve element 54 as it travels through the cage 52, bringing the ball valve element 54 to a second state of rest. If the valve 500 includes the second ball element 55, the projections 52A may be configured to directly inhibit movement of the second ball 55 as it moves. As the first ball valve element 54 cannot move past the second ball valve element 55, this means that both the first ball valve element 54 and the second ball valve element 55 are brought to the second state of rest. As such, the movement of the or each valve element 54, 55 is restricted within the cage 52.

The projections 52A may be positioned along the height of the cage 52. Each projection 52A may provide an obstruction for the ball valve element 54 to prevent the ball valve element travelling the full distance of the cage 52 when the valve 500 is inverted in the actuated position. The projections 52A ensure that even if the milk bottle is very full, the milk does not submerge the first valve element 54. By restricting the total movement of the ball valve element 54 from the first valve seat 57 to no more than a few millimetres (e.g. 3 mm), the milk will not completely submerge the ball valve element 54 and thus milk will not leak from the valve 500 when the bottle is returned to the rest position of 0° inclination.

In FIG. 23 a service position for the valve 500 is shown, this may be used for cleaning, repair, replacement or other service/maintenance type scenarios for the milk bottle and/or the valve 500. For this service position, the valve 500 may be inverted up until the point the valve is in the actuated position or alternatively be in the rest position. In this service position the or each ball valve element 54 may be forced beyond the protrusion(s) 52A. In order to achieve this, the cage 52 of the valve 500 may be flexible and/or deformable. The protrusion 52A then acts to retain the or each ball valve element 54 away from the first valve seat 57, thereby facilitating servicing of the valve 500 such as cleaning.

To return to an original arrangement, the or each ball valve element 54 is forcibly moved to pass the at least one protrusion 52B of the cage 52 towards the first valve seat 57.

In an intermediate position, the valve 500 is rotated from the rest position of the milk bottle lower end facing downwards, 0 degrees, to an angle wherein it is less than or equal to 90 degrees inclination. That is, the bottle is not beyond the horizontal. The intermediate position can be considered to be at any degree of inclination from 0 to 90 degrees, wherein the ball valve element 54 begins to move away from the central projection 59. The valve 500 may further comprise a guide configured to position the ball valve element to press against the first valve seat 57. For example, the guide may be formed from a slope or curvature in one of more side walls of the valve 500. In a particular form, the guide may be formed as a arcuate curve, such that the guide receive the curvature of the ball valve element 54.

As the ball valve element 54 moves away from the first valve seat 57 in the intermediate position, the guide directs the ball valve element 54 towards the first valve seat 57, thereby preventing the valve 500 from opening. Once the valve 500 passes the intermediate position, the ball valve element 54 overcomes the guide and opens the air flow pathway. Therefore, it is possible to prevent the bottle spilling when it is knocked over and not fully actuated by the bottle not rotating past the horizontal of the milk bottle.

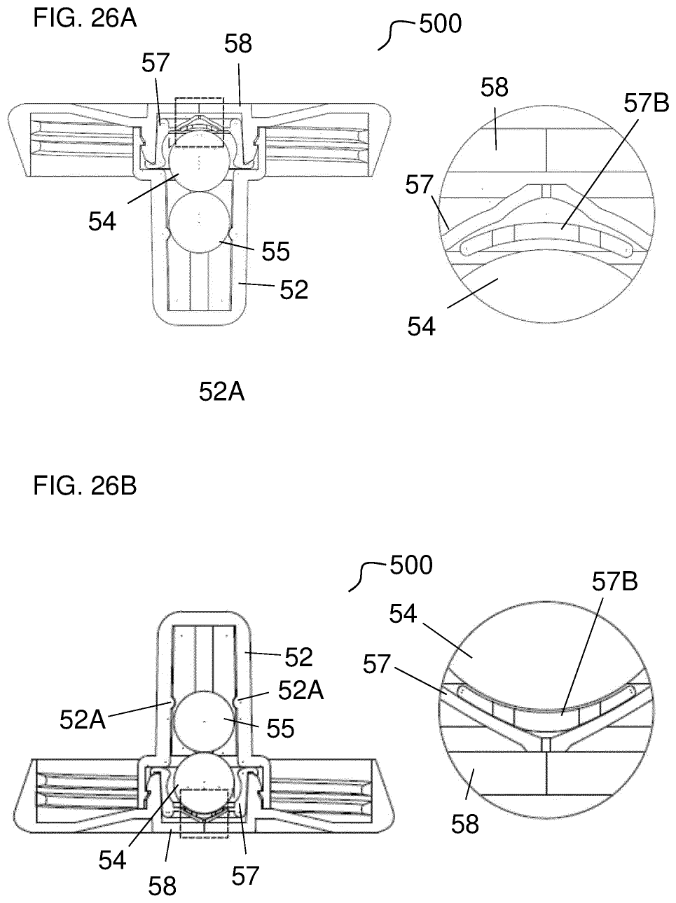

In a further embodiment as shown in FIGS. 25A, 25B, 26A and 26B, the valve 500 may further comprise an occluding member 57B. The occluding member 57B is provided between the first valve element 54 and the first valve seat 57. The occluding member 57A can act as a further seal to strengthen the seal between the first valve element 54 and the first valve seat 57.

The occluding member 57B may be a flange 2A protruding from the first valve seat 57 or a separately formed piece of membrane. The occluding member 57B may be a similar thickness to the membrane if the first valve seat 57 is formed as a membrane. The occluding member 57B preferably has a thickness in the range of 0.4 mm to 2 mm. The occluding member 57B preferably is a soft elastic material with a Shore hardness of 15 to 40.

If the occluding member 57B is formed as a separately formed piece of membrane, it may comprise one or more venting holes. An air flow pathway is then formed through said venting holes. This separately formed piece of membrane may be freely moveable within the cage 52

In the arrangement where the occluding member 57B is a flange, the flange may be cantilevered from a side wall of the first valve seat 57.

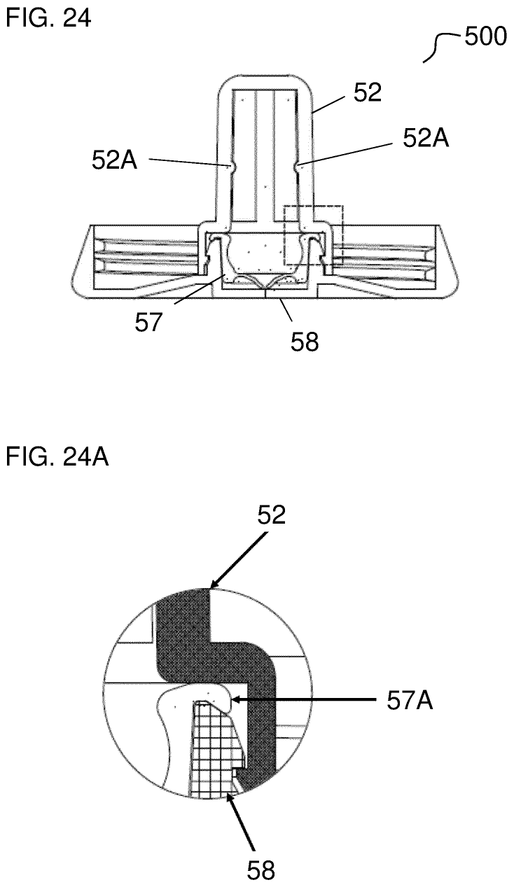

As shown in FIG. 24, a bottom portion of the infant milk bottle may be formed of a base that is securely fit with the main chamber of the milk bottle via, for example, a snap fit, screw fixture or any other semi-permanent and/or permanent fixture. The cage 52 may extend from the bottom portion. For example, the cage 52 may be attachable to the bottom portion. In particular, the cage 52 may be snap-fit to the bottom portion. In certain embodiments, a compressible flange may be provided between the cage 52 and the bottom portion in order to prevent leakage of fluid from the bottle. The compressible flange may be formed as a flange 57A extending from the first valve seat 57.

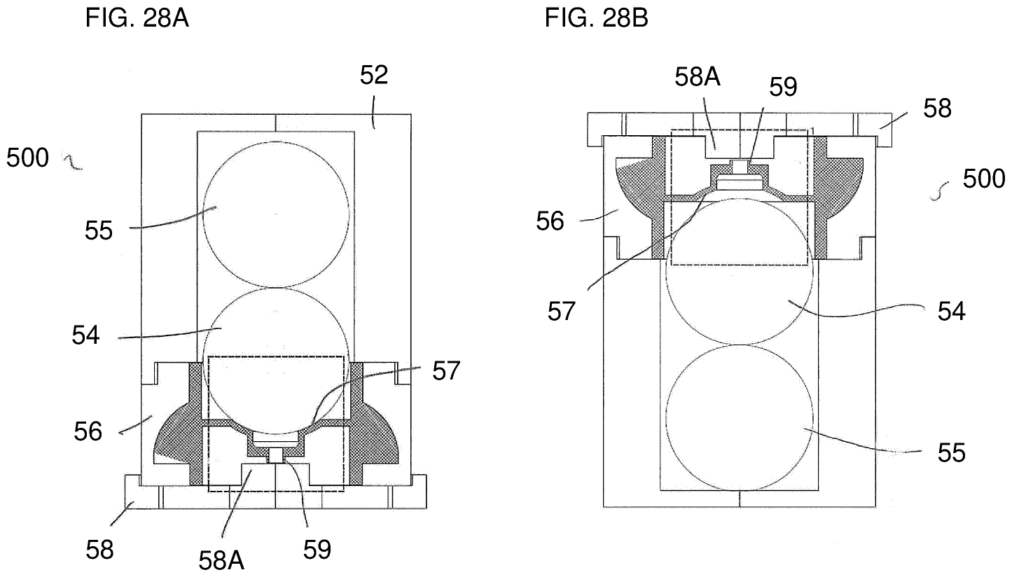

The alternative embodiments will now be described in reference to FIGS. 28A and 28B. In alternative embodiments the sealing element 58 is provided, attached to an opposite side of the valve unit 56 to the cage 52. The sealing element 58 comprises a central secondary valve seat 58A. In all embodiments, the valve seat 57 is a deformable, flexible component. The material of the valve seat 57 may have a Shore hardness of 15 to 40. For example, the valve seat 57 may be formed of silicone and retained within the valve unit 56.

In such embodiments, in the resting position, the weight of the ball valve element(s) 54, 55 acts to deform the valve seat 57 towards the sealing element. As a result, the central projection 59 contacts the secondary valve seat 58A, thereby blocking the flow pathway at a second point. Accordingly, flow through the valve 500 is blocked in two locations for a more reliable valve 500. The opening of this valve 500 is as described above, with the addition that the valve seat 57 deforms away from the central projection 59.

An assembly may be provided of the teat 100 attached to a milk bottle 42. The assembly may further include the non-return valve 300. Likewise, a kit of parts may be provided of the teat 100 and a milk bottle 42. The kit of parts may further include the non-return valve 300.

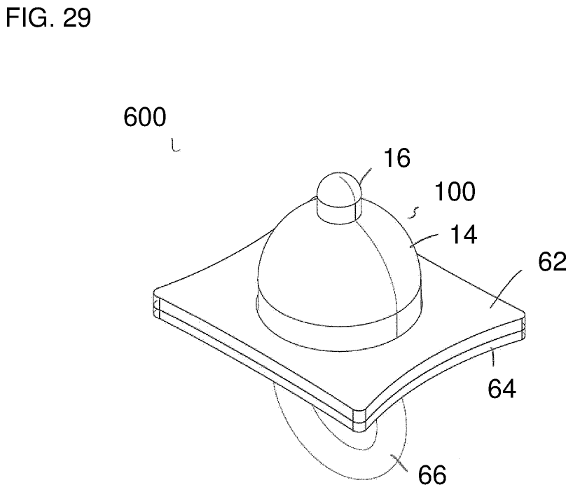

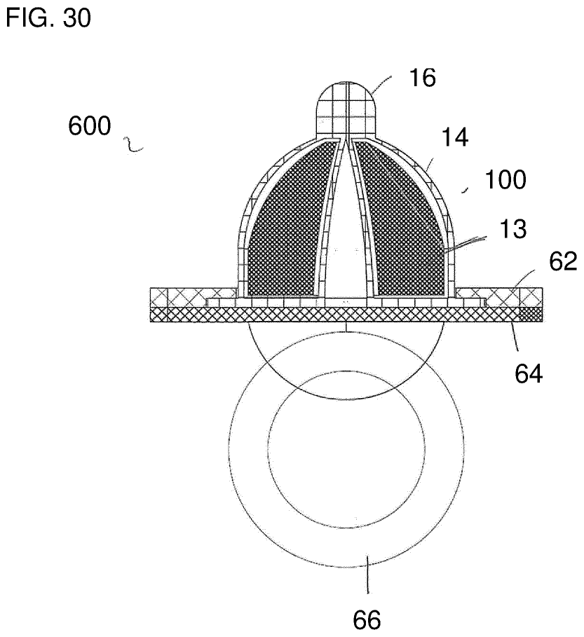

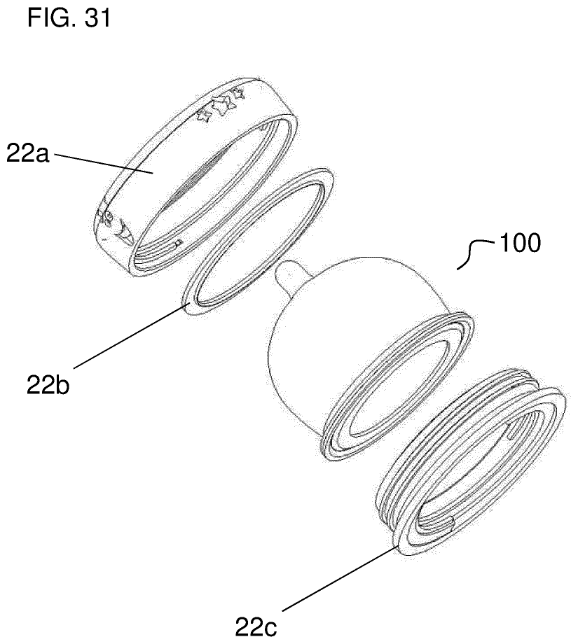

In a further embodiment of the present invention, a teat 100 substantially similar to that described above may be a sub-component of a pacifier 600 (also known as a dummy, soother or teether) as shown in FIGS. 29 and 30.

The teat 100 forms the portion of the pacifier 600 that the infant receives in their mouth. Instead of a bottle attachment portion 12, the teat 100 may comprise a guard 64 and/or guard attachment portion 62 for attaching the teat 100 to a guard 64. The guard 64 may be a component integral to the teat 100 or may be a separate component that the teat 100 is attached to. The guard 64 acts to prevent an infant from accidentally swallowing the pacifier 600.

Typically, the pacifier 600 will further comprise a ring 66 extending from the guard.

The teat 100 may not include the milk-flow pathway in such embodiments as it is not necessary in the embodiment for a pacifier 600. Instead, the compressible material 13 may extend across the entire inner area of the breast portion 14. Likewise, the nipple portion 16 may be a solid component with no milk-flow pathway extending therethrough. Alternatively, the teat 100 may be substantially identically arranged, but with no milk-flow pathway extending through the nipple portion 16. That is, the nipple portion 16 may be a solid component.

In alternative embodiments, the teat 100 may be identical to those as described above, and may be able to connect to a pacifier 600 via the bottle attachment portion 12. In such embodiments, the same teat 100 may be used for bottle feeding and for a pacifier 600. Thus only a single teat 100 needs to be transported and can be switched between the two uses as necessary.

The teat 100 and associated components described above provide a more accurate simulation of the human breast which has significant advantages in bottle feeding and pacifier sucking.

The teat 100 and associated components described above provide a pump like mechanism for suction of the milk to flow along the milk flow pathway. This pump like suction, does not rely solely upon compression of the teat to provide an opening in the nipple outlet. Instead, the infant latches around the bottle creating an air tight seal. As they move their mouth, the volume in the oral cavity increases and causes a negative pressure (i.e. suction). This causes a pressure gradient due to a difference in pressure between the oral cavity of the infant and the milk flow pathway, which results in milk being expelled from the bottle to the infant. This movement and expression method is more similar to breastfeeding.

In the suction cycle, a peristaltic movement is typical of a posterior part of the tongue during swallowing. This pump mechanism is caused by variation of volume in cavities inside the oral cavity and milk flow pathway. The presence of a rigid nipple prevents collapse of milk flow pathway through the nipple bore when this pump mechanism is used.

### CLAUSES

1. A teat for a milk bottle, comprising:
   an attachment portion for attaching the teat to a milk bottle;
   a breast portion extending from the attachment portion;
   a compressible material substantially filling the breast portion
   a nipple portion extending from the breast portion and being narrower than the breast portion, the nipple portion comprising an outlet; and
   a milk-flow pathway extending through the breast portion, the compressible material and the nipple portion for the passage of milk from a milk bottle attached to the attachment portion to the outlet,
      wherein the breast portion comprises a flexible skin fully enclosing the compressible material, the flexible skin separating the compressible material from the milk-flow pathway.
2. The teat of any preceding clause, wherein the flexible skin is formed of first and second bonded segments, the first segment extending around an outer surface of the compressible material and the second section extending around an inner surface of the compressible material.
3. The teat of clause 1, wherein the flexible skin is a single integral piece of material.
4. The teat of any preceding clause, wherein an outer surface of the breast portion is substantially dome shaped, in particular preferably substantially breast shaped.
5. The teat of clause 4, wherein the dome or breast has a radius of at least 2 cm, preferably at least 3 cm.
6. The teat of any preceding clause, wherein the skin is formed of a silicone.
7. The teat of any preceding clause, wherein the compressible material is an expanded foam or a silicone.
8. The teat of any preceding clause, wherein the compressible material has a Shore OO of between 45 to 70.
9. The teat of any preceding clause, wherein the nipple portion is less compressible than the compressible material.
10. A method of manufacturing a teat for a milk bottle comprising the steps of:
   providing a compressible material having a passage extending therethrough;
   enclosing the compressible material within a flexible skin to form a breast portion of the teat, the skin extending through the passage and separating the compressible material from a milk-flow pathway.
11. A teat for a milk bottle manufactured according to the method of clause 10.
12. A teat for a milk bottle, comprising:
   an attachment portion for attaching the teat to a milk bottle;
   a breast portion extending from the attachment portion, the breast portion comprising a compressible material substantially filling the breast portion;
   a nipple portion extending from the breast portion and being narrower than the breast portion, the nipple portion comprising an outlet and being less compressible than the filling material; and
   a milk-flow pathway extending through the breast portion and the nipple portion for the passage of milk from a milk bottle attached to the attachment portion to the outlet.
13. The teat of clause 12, wherein the portion of the milk-flow pathway extending through the nipple portion has a diameter no greater than 20% of the maximum diameter of the nipple portion, preferably no greater than 10%, most preferably no greater than 5%.
14. The teat of clause 12 or 13, wherein the nipple portion is at least an upper 0.5 centimetres of the teat, preferably at least an upper 1 centimetre of the teat.
15. The teat of any of clauses 12 to 14, further comprising a flexible skin fully enclosing the compressible material and separating the compressible material from the milk-flow pathway.
16. The teat of clause 15, wherein the nipple portion is formed as a thick segment of the flexible skin, the portion of the milk-flow pathway extending through the nipple portion formed as a bore through the thick segment of the flexible skin.
17. The teat of any of clauses 12 to 16, wherein the nipple portion is formed of a material having a shore A hardness of 15 to 30.
18. A teat assembly for a milk bottle, comprising:
   a teat comprising:
      an attachment portion for attaching the teat to a milk bottle; and
      a milk-flow pathway for a flow of milk from the milk bottle;
   a one-way valve configured to permit milk flowing from a milk bottle attached to the attachment portion to the milk-flow pathway and inhibit milk flowing from the milk-flow pathway to the bottle.
19. The teat assembly of clause 18, wherein the one-way valve is formed as a slit in a flexible material.
20. The teat assembly of clause 19, wherein the flexible material is supported by a rigid frame.
21. The teat assembly of any of clauses 18 to 19, wherein the teat is according to any of clauses 1 to 915 or 11 to 17.
22. An assembly comprising:
   a milk bottle; and
   a teat according to any of clauses 1 to 915 or 11 to 17 or a teat assembly according to any of clauses 18 to 21, the teat or teat assembly attached to the milk bottle via the attachment portion.
23. A kit comprising:
   a milk bottle; and
   a teat according to any of clauses 1 to 915 or 11 to 17 or a teat assembly according to any of clauses 18 to 21.
24. A teat for a pacifier, comprising:
   an attachment portion for attaching the teat to a pacifier;
   a breast portion extending from the attachment portion;
   a compressible material substantially filling the breast portion
   a nipple portion extending from the breast portion and being narrower than the breast portion, wherein the breast portion comprises a flexible skin fully enclosing the compressible material.
25. A pacifier comprising:
   a guard for inhibiting an infant from swallowing the pacifier;
   a teat according to any of clauses 1 to 915 or 11 to 17, extending from the guard.
26. A one-way valve comprising:
   a valve unit comprising:
   a first valve seat, comprising a flow pathway extending from the first valve seat to
   an opening in a central projection, wherein the first valve seat is deformable in the direction of the central projection;
   a valve element, moveable towards and away from the first valve seat and sealingly engageable therewith; and
   a second valve seat arranged to seal with the central projection,
      wherein the valve seat is configured to deform from a force applied by the first valve element towards the second valve seat to thereby seal the opening in the central projection against the second valve seat.
27. The one-way valve of clause 26, wherein the valve element is a ball valve element, preferably a ball bearing.

1. A teat for a milk bottle, comprising: an attachment portion for attaching the teat to a milk bottle; a breast portion extending from the attachment portion, the breast portion comprising a compressible material; a nipple portion extending from the breast portion and being narrower than the breast portion, the nipple portion comprising an outlet; and a milk-flow pathway extending through the breast portion, the compressible material and the nipple portion for the passage of milk from a milk bottle attached to the attachment portion to the outlet, wherein the breast portion comprises a flexible skin fully enclosing the compressible material, the flexible skin separating the compressible material from the milk-flow pathway.

2. A teat for a milk bottle, comprising: an attachment portion for attaching the teat to a milk bottle; a breast portion extending from the attachment portion, the breast portion comprising a compressible material; a nipple portion extending from the breast portion and being narrower than the breast portion, the nipple portion comprising an outlet and being less compressible than the filling material; and a milk-flow pathway extending through the breast portion and the nipple portion for the passage of milk from a milk bottle attached to the attachment portion to the outlet.

3. The teat of claim 2, wherein the breast portion comprises a flexible skin fully enclosing the compressible material, the flexible skin separating the compressible material from the milk-flow pathway

4-6. (canceled)

7. The teat of claim 1, wherein the skin is formed of a silicone.

8. The teat of claim 1, wherein the compressible material is formed as a single piece of material with a bore for receiving the flexible skin.

9. The teat of claim 8, wherein the flexible skin further comprises a neck portion, and the neck portion is received by the bore of the compressible material.

10. The teat of claim 1, wherein an outer surface of the breast portion is substantially dome shaped.

11. (canceled)

12. The teat of claim 1, wherein the compressible material is a solid.

13. The teat of claim 1, wherein the compressible material is an expanded foam or a silicone.

14. (canceled)

15. The teat of claim 1, wherein the nipple portion is less compressible than the compressible material.

16. The teat of claim 1, wherein the portion of the milk-flow pathway which extends through the nipple portion is a through bore through a generally solid nipple portion.

17. The teat of claim 1, wherein an angle is defined between the breast portion and the attachment means, wherein the angle is acute.

18. The teat of claim 1, wherein an angle is defined between the breast portion and the nipple portion, wherein the angle is obtuse.

19. The teat of claim 1, wherein the compressible material is formed generally in a crenellation or castellation shape.

20. The teat of claim 1, wherein the compressible material is formed of a central region, with a plurality of spaced protrusions extending therefrom.

21. (canceled)

22. The teat of claim 1, wherein the compressible material and/or breast portion have a thickness in the region of 5 millimetres to 20 millimetres.

23. The teat of claim 1, wherein the portion of the milk-flow pathway extending through the nipple portion has a diameter no greater than 20% of the maximum diameter of the nipple portion.

24. The teat of claim 1, wherein the nipple portion is at least an upper 0.5 centimetres of the teat.

25. The teat of claim 1, wherein the nipple portion is formed as a thick segment of the flexible skin, the portion of the milk-flow pathway extending through the nipple portion formed as a bore through the thick segment of the flexible skin.

26. (canceled)

27. A method of manufacturing a teat for a milk bottle comprising the steps of: providing a compressible material having a passage extending therethrough; enclosing the compressible material within a flexible skin to form a breast portion of the teat, the skin extending through the passage and separating the compressible material from a milk-flow pathway.

28-56. (canceled)
